(19) United States
(12) Patent Application Publication
(10) Pub. No.: US 2012/0330731 A1
(43) Pub. Date: Dec. 27, 2012

(54) System and Method for Processing Vote-By-Mail Ballot Envelopes

(76) Inventors: Jerald Bradley Wagoner, Everett, WA (US); Brett Hamilton Barrett, Everett, WA (US); Gary Stanley Lemmon, Coupeville, WA (US); Edward Walter Poole, Lynnwood, WA (US); Harminder Patria, (US); Krista W. Anderson, Lake Stevens, WA (US)

(21) Appl. No.: 13/167,139

(22) Filed: Jun. 23, 2011

(51) Int. Cl. G06F 17/00

(52) U.S. Cl. 705/12

(57) ABSTRACT

A system and method for processing vote-by-mail ballot envelopes is disclosed. The system comprises a processor operable to asynchronously process each of a plurality of ballot envelopes by (i) verifying that the registered voter associated with the ballot envelope is eligible to vote, (ii) verifying that a signature written on the ballot envelope corresponds to the signature of the registered voter, (iii) verifying that personal information written on the ballot envelope corresponds to the personal information of the registered voter, and (iv) generating batch information if the ballot envelope passes all of the verification steps or exception information if the ballot envelope fails any one of the verification steps. The system also comprises a storage device operable to store the batch information or exception information, as applicable, for each of the ballot envelopes.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Vote-by-mail ballots are often used in elections as part of the absentee voting process. Each registered voter who has requested to vote by mail is mailed a ballot packet in advance of the election. The ballot packet includes a ballot and an envelope for returning the ballot to a central election office. Upon receipt of the ballot packet, the voter makes his/her voting selections by marking the appropriate marks spaces on the ballot. The voter then places the marked ballot into the return ballot envelope, signs the outside of the ballot envelope, and mails the ballot envelope hack to the central election office. The processing of ballot envelopes returned to the central election office can be complex, costly and labor-intensive. Accordingly, there is a need for an improved system that can process ballot envelopes with minimal human intervention.

### BRIEF SUMMARY OF THE INVENTION

The present invention is directed to a system and method for processing vote-by-mail ballot envelopes that have been returned to a central election office. In an exemplary embodiment, the system includes a central processing server that operates as the central communication hub to control the processing of a plurality of ballot envelopes. The central processing server is in communication with a mail system that receives a stack of ballot envelopes and transports each ballot envelope to one of a plurality of mail bins, a voter registration system that maintains voter registration records for a plurality of registered voters, an automated signature recognition server that enables an automated comparison of signatures, and a plurality of workstations that enable a manual comparison of signatures, as will be described below.

In operation, the central processing server receives envelope data associated with each ballot envelope from the mail system. The envelope data includes a voter identifier and a voting precinct identifier decoded from a barcode on the ballot envelope, as well as an image of the ballot envelope. The central processing server uses the image of the ballot envelope to extract an image of a signature written on the ballot envelope and an image of personal information (e.g. a driver's license number, a birth date, a residential address, etc.) written on the ballot envelope. The central processing server also receives voter data associated with the voter identifier from the voter registration system. The voter data includes voter eligibility information for a registered voter, at least one image of a signature of the registered voter, and personal information (e.g. a driver's license number, a birth date, a residential address, etc.) of the registered voter.

Next, the central processing server performs several verification steps. First, the central processing server verifies that the registered voter associated with the voter identifier is eligible to vote based on the voter eligibility information. Second, the central processing server verifies that the signature written on the ballot envelope corresponds to the signature of the registered voter. This signature comparison is performed automatically by the automated signature recognition server or through a manual comparison at one of the workstations. Third, the central processing server verifies that the personal information written on the ballot envelope corresponds to the personal information of the registered voter. This personal information comparison is performed automatically through the use of optical character recognition (OCR) or through a manual comparison at one of the workstations.

The central processing server then generates envelope endorsement data for the ballot envelope. The envelope endorsement data includes a date and time that the ballot envelope was processed, a voter identifier, and either batch information or exception information. The envelope endorsement data includes batch information if the ballot envelope passes all of the verification steps. The batch information includes a voting precinct identifier that identifies the voting precinct of the registered voter, a batch number that identifies a batch of envelopes associated with the voting precinct, and a sequence number that identities a sequential position of an envelope within the batch of envelopes. Preferably, the central processing server generates the batch and sequence numbers based on user-defined hatch criteria for the voting precinct.

Alternatively, the envelope endorsement data includes exception information if the ballot envelope fails any one of the verification steps. The exception information includes a human-readable description of the exception associated with the ballot envelope, such as a reason why the registered voter associated with the voter identifier is not eligible to vote, an indication that the signature written on the ballot envelope does not correspond to the signature of the registered voter, or an indication that the personal information written on the ballot envelope does not correspond to the personal information of the registered voter.

Next, the central processing server transmits the envelope endorsement data associated with the ballot envelope to the mail system for further processing of the ballot envelope. For example, the mail system uses the envelope endorsement data to generate and print a label that is affixed to the ballot envelope, and then the ballot envelope is delivered to one of a plurality of mail bins. Preferably, the mail system is operable to asynchronously process the ballots envelopes such that each ballot envelope is processed in a single pass through the system.

### BRIEF DESCRIPTION OF THE DRAWINGS

FIG. 1 is a block diagram of a system for processing ballot envelopes in accordance with an exemplary embodiment of the present invention.

FIG. 2 illustrates the back side of an exemplary ballot envelope that is processed using the system of FIG. 1.

FIGS. 3A and 3B show a process flow diagram of an exemplary method for processing each of the ballot envelopes using the system of FIG. 1.

FIG. 4A illustrates an exemplary screen shot of the display device of the central processing server shown in FIG. 1 during the signature cropping configuration process.

FIG. 4B is an enlarged view of the image of the “Barcode and Signature Crop” shown in FIG. 4A.

FIG. 4C is an enlarged view of the “ASR Signature Crop” shown in FIG. 4A.

FIG. 5 illustrates an exemplary screen shot of the display device of one of the workstations shown in FIG. 1 during the manual signature verification process.

FIG. 6 illustrates an exemplary screen shot of the display device of the central processing server shown in FIG. 1 during the batch set-up process.

### DETAILED DESCRIPTION OF EXEMPLARY EMBODIMENT

The present invention is directed to a system and method for processing vote-by-mail ballot envelopes that have been returned by registered voters to a central election office. While the invention will be described in detail below with reference to an exemplary embodiment, it should be understood that the invention is not limited to the specific system configuration or methodology of this embodiment. In addition, although the exemplary embodiment is described as embodying several different inventive features, one skilled in the art will appreciate that any one of these features could be implemented without the others in accordance with the invention.

Ballot Envelope Processing System

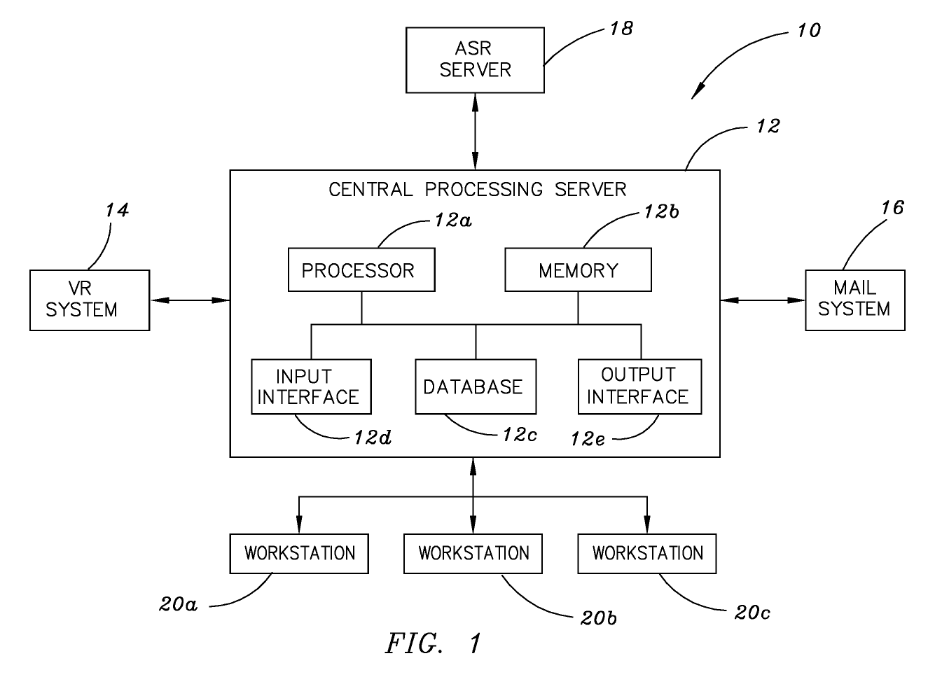

Referring now to FIG. 1, an exemplary embodiment of a ballot envelope processing system in accordance with the present invention is shown generally as reference numeral 10. System 10 generally includes a central processing server 12 that is connected to a voter registration system 14, a mail system 16, an automated signature recognition server 18, and a plurality of workstations 20a, 20b and 20c (although any number of workstations may be provided). As described below, system 10 is operable to asynchronously process a plurality of ballot envelopes such that each ballot envelope is processed in a single pass through system 10.

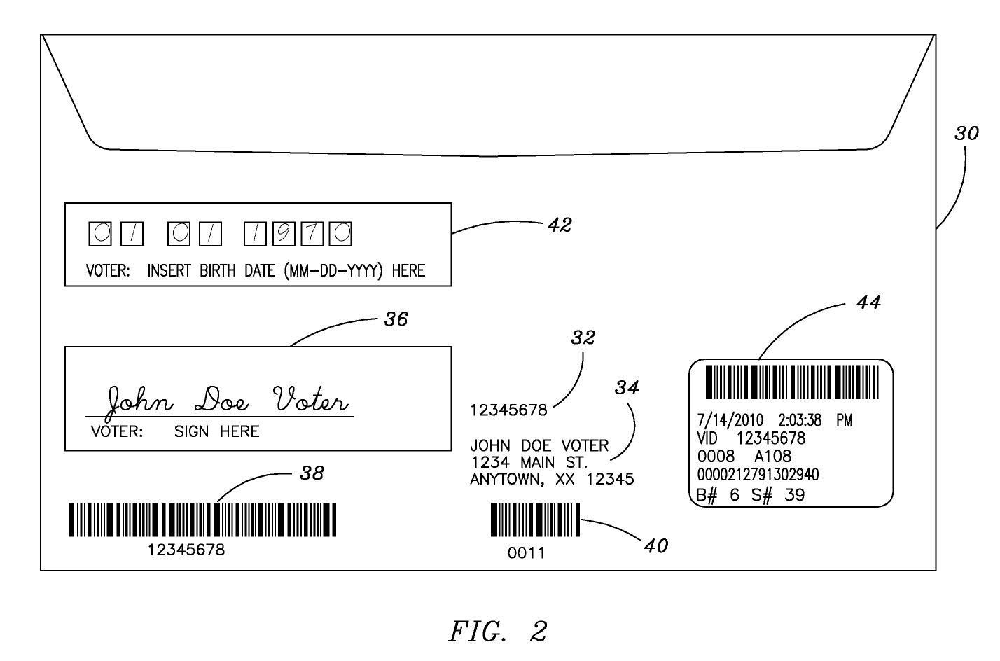

An exemplary ballot envelope 30 that is processed by system 10 is shown in FIG. 2 (which shows the back side of the ballot envelope). Ballot envelope 30 includes a voter identifier 32 that uniquely identifies a registered voter, and a textual portion 34 that includes the name of the registered voter and a residential address on record for the registered voter. Ballot envelope 30 also includes a signature box 36 where the registered voter can provide his/her signature. In addition, ballot envelope 30 includes a first barcode 38 that encodes the voter identifier and a second barcode 40 that encodes a precinct identifier associated with the registered voter, wherein barcodes 38 and 40 may comprise any type of barcode known in the art (e.g., a two-dimensional or three-dimensional barcode). In the illustrated example, the voter identifier and precinct identifier are numeric identifiers (i.e., the voter identifier is 12345678 and the precinct identifier is 0011); however, such identifiers may comprise any string of alphanumeric characters. Also, it should be understood that the voter identifier and precinct identifier could be encoded in a single barcode. In addition, other types of information may be encoded in one or more barcodes as desired by a voting jurisdiction.

Optionally, ballot envelope 30 also includes a personal identification box 42 where the registered voter can provide specific personal information in the designated input boxes. In the illustrated example, the registered voter is required to write his/her birth date in the designated input boxes. Of course, personal information box 42 may require the registered voter to provide other types of personal information, such as the voter's driver's license number, the voter's residential address, or any other personal information stored in voter registration system 14 so that a comparison may be made in accordance with the present invention, as described below.

Finally, FIG. 2 shows a label 44 affixed to ballot envelope 30. It should be understood that label 44 is not affixed to ballot envelope 30 when received from the registered voter, but is affixed to ballot envelope 30 by mail system 16 during the processing of ballot envelope 30, as described below. In the illustrated example, label 44 includes a barcode that encodes an envelope identifier and five lines of textual information. The first lines provides the date and time that ballot envelope 30 was processed, the second line provides the voter identifier, the third line provides an envelope status code (e.g., 0008) and a mail bin location in which ballot envelope 30 is to be placed (e.g., A108), the fourth lines provides the envelope identifier, and the fifth line provides the batch number and sequence number associated with ballot envelope 30 (which, if a ballot envelope is not verified, is replaced with exception information as described below). Preferably, the information provided on label 44 and the format of such information is customizable in accordance with the preferences of the voting jurisdiction. In addition, it should be understood that the information shown on label 44 may alternatively be printed directly on ballot envelope 30.

Referring back to FIG. 1, central processing server 12 is the central communication huh that controls all of the processes performed by system 10. Central processing server 12 includes at least one processor 12a that executes instructions stored in a memory 12b or other computer-readable medium for performing the method of the present invention, as described below. Central processing server 12 also includes at least one database 12c that is accessible by the processor 12a for storing various types of data, as described below. Of course, the data may be stored in other types of data storage structures known in the art. In addition, central processing server 12 includes an input interface 12d and an output interface 12e that allow communication with peripheral devices (e.g., a display device, a standard keyboard, a mouse, or other types of input devices known in the art) and with the other system components shown in FIG. 1. While central processing server 12 is illustrated as a single processing server, one skilled in the art will appreciate that system 10 may be implemented with any number of processing servers without departing from the scope of the present invention.

Central processing server 12 is connected to a voter registration system 14, which stores a database containing the voter registration records for a plurality of registered voters. For each registered voter, the data stored in the database may include the voter's name, residential address, party affiliation, voter identifier, voting precinct identifier associated with the voter, birth date, driver's license number, voter eligibility status, and one or more images of signatures known to be authored by the registered voter (e.g., the voter's signature from his/her voter card). If the registered voter votes by mail in a particular election, the data stored in the database may also include the date that the voter requested an absentee ballot, the date that the central election office mailed the absentee ballot to the voter, the residential address to which the absentee ballot was mailed, and the date that the absentee ballot was returned to the central election office. The database may also contain the voting history of the registered voter or other information considered relevant by the voting jurisdiction, or as required by law.

As described below, central processing server 12 receives voter data from voter registration system 14 in connection with the processing of ballots envelopes returned by registered voters and also transmits information back to voter registration system 14 so as to update the voting history of those registered voters. For each registered voter, the voter data received by central processing server 12 may include all or a portion of the data stored in the database of voter registration system 14. The information transmitted back to voter registration system 14 may include the voter identifier, the date that the ballot envelope was processed, an envelope identifier, an envelope status code, an image of the ballot envelope, an image of the signature written on the ballot envelope (which may supplement the existing signature images to provide for more accurate signature matching over time, as described below), batch information for the ballot envelope (e.g., a voting precinct identifier, a batch number and a sequence number) or exception information for the ballot envelope (i.e., a textual description of an exception associated with the ballot envelope), as described below. All or a portion of this information may alternatively be exported to another file location specified by the voting jurisdiction to thereby create an electronic audit trail for the election.

In one aspect of the invention, voter registration system 14 imports data from and exports data to the official voter registration system maintained by the voting jurisdiction on a periodic basis (e.g., the synchronization may occur on a daily basis or several times a day). Voter registration system 14 may store data for all registered voters, or, only those registered voters who have been mailed absentee ballots in advance of the election. In another aspect of the invention, voter registration system 14 is the official voter registration system maintained by the voting jurisdiction. In this case, there is a “live” connection between central processing server 12 and the official voter registration system such that the data for all registered voters is always up-to-date.

Referring still to FIG. 1, central processing server 12 is also connected to a mail system 16, which performs a variety of functions in relation to the ballot envelopes processed by system 10. In general, mail system 16 receives a stack of ballot envelopes and processes each ballot envelope in the stack. The processes for each ballot envelope will be described with reference to the exemplary ballot envelope 30 shown in FIG. 2. First, mail system 16 captures a digital image of the back side of ballot envelope 30. This digital image is analyzed to decode the voter identifier and voting precinct identifier from barcodes 38 and 40, respectively. Alternatively, mail system 16 may include a barcode reader that directly reads and decodes barcodes 38 and 40 on ballot envelope 30. Mail system 16 also assigns a unique envelope identifier to ballot envelope 30. Mail system 16 then transmits envelope data to central processing server 12 for processing, as described below.

In the exemplary embodiment, the envelope data comprises the image of the ballot envelope, the voter identifier, the precinct identifier and the envelope identifier. Of course, one skilled in the art will appreciate that mail system 16 may transmit other types of envelope data to central processing server 12 in accordance with the present invention. For example, mail system 16 may additionally extract various images from the image of the ballot envelope, such as an image of signature box 36 and barcodes 38 and 40 and/or an image of personal information box 42, and include such images in the envelope data. In the exemplary embodiment, however, the extraction of such images is performed by central processing server 12, as described below.

After central processing server 12 has processed the envelope data, it transmits envelope endorsement data back to mail system 16 for use in generating and printing label 44 (see FIG. 2). In the exemplary embodiment, the envelope endorsement data comprises the date and time that the ballot envelope was processed, the voter identifier, an envelope status code, the envelope identifier, and the batch number and sequence number associated with the ballot envelope (which, if the ballot envelope is not verified, is replaced with exception information as described below). Of course, one skilled in the art will appreciate that central processing server 12 may transmit other types of envelope endorsement data to mail system 16 in accordance with the present invention.

Mail system 16 uses the envelope endorsement data to determine a mail bin from amongst a plurality of mail bins in which ballot envelope 30 is to be placed (e.g., bin A108 as shown on label 44 in FIG. 2). In the exemplary embodiment, if the ballot envelope has passed all of the verification steps (as described below), then the voting precinct identifier is used to determine the appropriate mail bin. However, if the ballot envelope is not verified, then the exception information is used to determine the appropriate mail bin. Preferably, mail system 16 is scalable and provides as few as 32 mails bins and up to 1,088 mail bins to thereby handle voting jurisdictions of different sizes. Finally, mail system 16 affixes the printed label 44 to ballot envelope 30 and transports ballot envelope 30 to the appropriate mail bin.

It can be appreciated that label 44 affixed to ballot envelope 30 provides a paper audit trail that can be used to identify and locate ballot envelope 30 at a later time. Accordingly, if an election official wishes to verify that all returned ballot envelopes are accounted for in a particular batch, the election official may retrieve such batch from the appropriate mail bin and review the labels affixed to the ballot envelopes in that hatch. Furthermore, if an election official wishes to retrieve a particular ballot envelope in a batch, such election official can quickly locate the envelope based on the label affixed to the ballot envelope.

Preferably, mail system 16 is operable to process each of the ballot envelopes asynchronously and substantially independently from one another such that a plurality of ballot envelopes are being processed at the same time. If there is some sort of delay corresponding to a particular ballot envelope (e.g., manual comparison of the signatures and/or personal information at one of workstations 20a, 20b and 20c, as discussed below), other ballot envelopes may continue to be processed and transported to the appropriate mail bins. A commercially available mail system that is particularly suitable for use in accordance with the present invention is the Mail Matrix™ sold by OPEX Corporation of Moorestown, N.J.

Referring still to FIG. 1, central processing server 12 is also connected to an automated signature recognition server 18, which executes a software application that electronically compare two signatures and provides a confidence factor or other indicator of reliability of the comparison. The confidence factor may be determined based on a variety of elements, such as letter formation, ligatures, loop and stroke shapes, complete or incomplete connecting strokes, slant, size, letter and word proportions, and other relevant characteristics known to those skilled in the art.

As described below, central processing server 12 transmits the image of the signature written on the ballot envelope and one or more images of signatures of the registered voter (as received from voter registration system 14) to automated signature recognition server 18 for comparison. If the signatures sufficiently match, automated signature recognition server 18 sends a signal to central processing server 12 indicating that the signature written on the ballot envelope is verified. Conversely, if the signatures do not sufficiently match, automated signature recognition server 18 sends a signal to central processing server 12 indicating that the signature written on the ballot envelope is not verified.

In the exemplary embodiment, the software application executed on automated signature recognition server 18 allows a voting jurisdiction to control the level of signature-matching by allowing a user to set a numeric confidence threshold for the automated signature verification. For example, if the confidence factor is provided on a scale of 1-99 (wherein a higher number requires greater scrutiny and a lower number requires less scrutiny), a user may determine through testing that the desired confidence threshold is 16. Thus, if the confidence factor for a particular ballot envelope is 16 or higher, the signatures will be deemed to sufficiently match. Conversely, if the confidence factor for a particular ballot envelope is lower than 16, the signatures will not be deemed to sufficiently match.

Preferably, automated signature recognition server 18 is able to electronically compare the signature written on the ballot envelope to each of a plurality of signatures of the registered voter stored in voter registration system 14. In this case, automated signature recognition server 18 determines a confidence factor for each comparison, calculates the average of the various confidence factors, and compares the average to the confidence threshold. For example, if there are four signatures of the registered voter stored in voter registration system 14, automated signature recognition server 18 compares the signature written on the ballot envelope to each of these stored signatures and determines the confidence factor for each comparison. e.g., 14, 20, 18 and 16. Automated signature recognition server 18 then calculates an average of the four confidence factors, e.g., 17. Because the average of the four confidence factors is greater than 16, automated signature recognition server 18 sends a signal to central processing server 12 indicating that the signature written on the ballot envelope is verified. A commercially available software application that is particularly suitable for use in accordance with the present invention is SignatureXpert® sold by Parascript, LLC of Longmont, Colo.

Referring still to FIG. 1 central processing server 12 is also connected to a plurality of workstations 20a, 20b and 20c. Each of workstations 20a, 20b and 20c comprises any suitable computing system (such as a programmed general purpose computer, a special purpose computer, or the like). One or more peripheral devices may also be provided, such as a display device, a standard keyboard, a mouse, or other types of input devices known in the art.

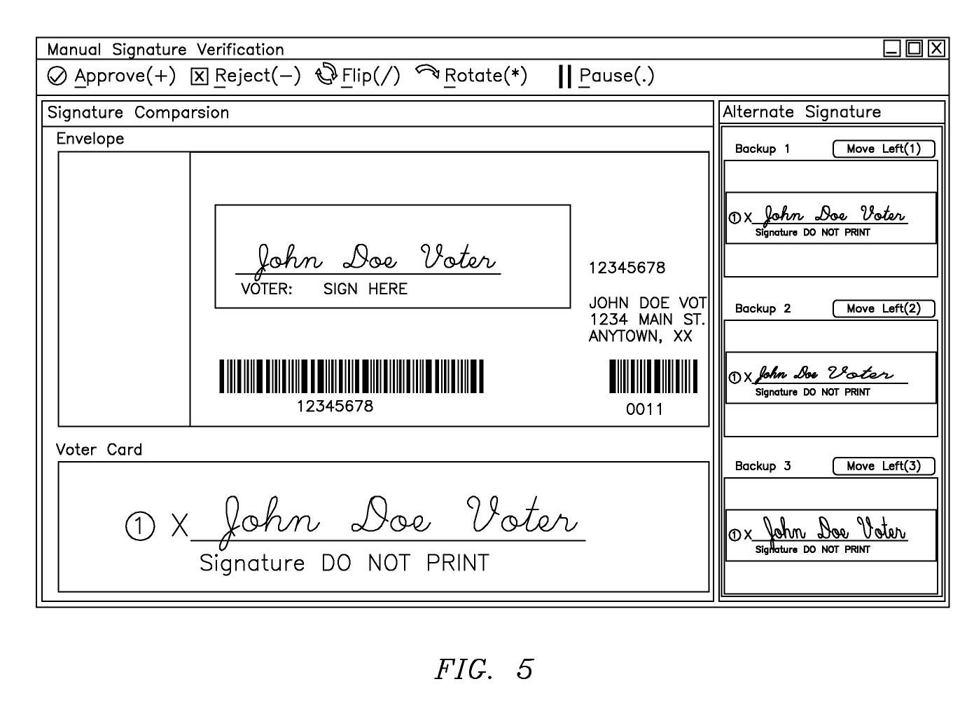

As described below, if automated signature recognition server 18 is not able to verify the authenticity of the signature written on the ballot envelope, central processing server 12 causes the signature written on the ballot envelope to be simultaneously displayed with the one or more signatures of the registered voter (as received from voter registration system 14) on one of workstations 20a, 20b and 20c. An election official then views and compares the signatures manually to ascertain whether the signatures are authored by the same individual (i.e., the registered voter). The election official selects an “Approve” option if he/she determines that the signatures are authored by the same individual, whereby the workstation sends a signal to central processing server 12 indicating that the signature written on the ballot envelope is verified. Conversely, the election official selects a “Reject” option if he/she determines that the signatures are not authored by the same individual, whereby the workstation sends a signal to central processing server 12 indicating that the signature written on the ballot envelope is not verified. This manual signature verification process will be described in greater detail below with reference to FIG. 5.

It should be understood that system 10 shown in FIG. 1 is merely an example of a system that may be used to process ballot envelopes and that other system configurations could also be employed in accordance with the present invention. For example, one skilled in the art will appreciate that the software application executed on automated signature recognition server 18 could alternatively be executed on central processing server 12 such that automated signature recognition server 18 would not be required. Also, one skilled in the art will appreciate that any function performed by one of the system components could alternatively be performed by another system component. Thus, the present invention is not limited to the configuration of system 10 shown in FIG. 1.

Method for Processing Ballot Envelopes

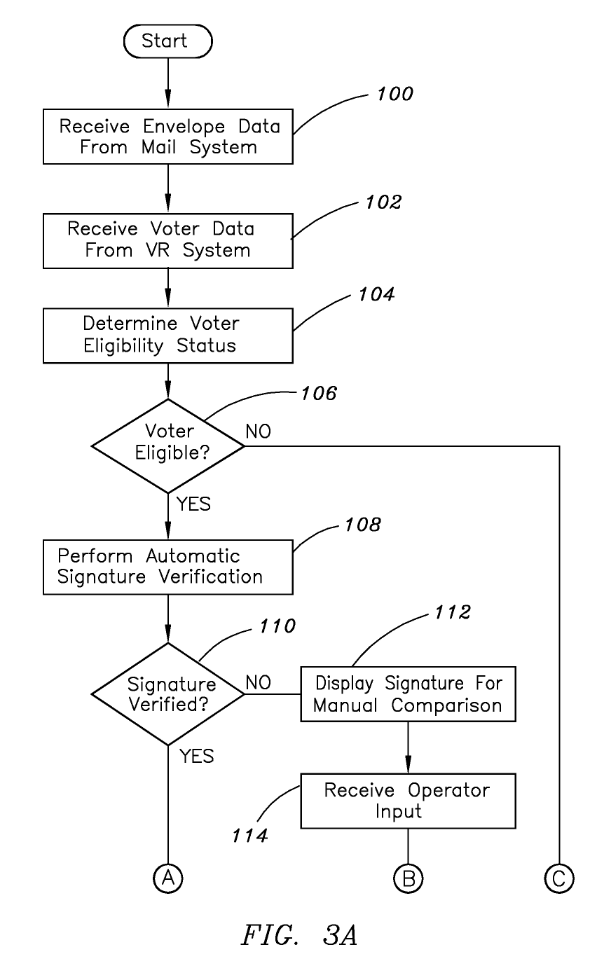

Referring to FIGS. 3A and 3B, a process flow diagram of an exemplary method for processing each of the ballot envelopes using the system of FIG. 1 in accordance with the present invention will be described with reference to steps 100 to 130.

In step 100, central processing server 12 receives envelope data from mail system 16. As discussed above, the envelope data comprises the image of the ballot envelope, the voter identifier, the precinct identifier and the envelope identifier, although other types of envelope data may be received in accordance with the present invention. Central processing server 12 then executes a software application that extracts various images from the image of the ballot envelope. In the exemplary embodiment, the software application comprises an image cropping tool that enables a voting jurisdiction to configure the images to be extracted from the image of the ballot envelope in advance of the election, including the signature box and adjacent barcodes on the ballot envelope (e.g., signature box 36 and barcodes 38 and 40 shown in FIG. 2) and the personal information box on the ballot envelope (e.g., personal information box 42 shown in FIG. 2).

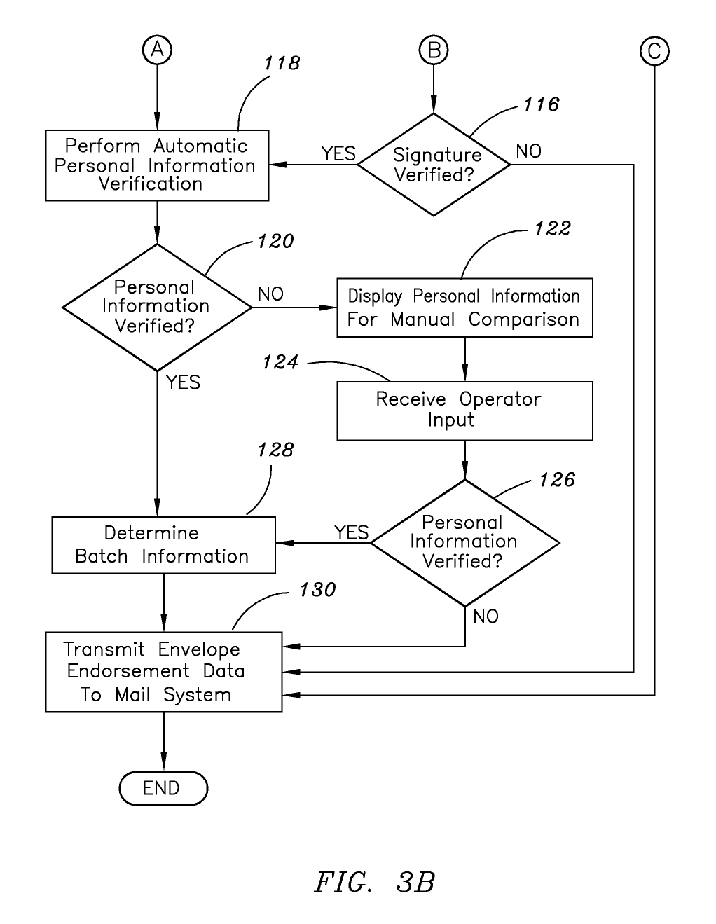

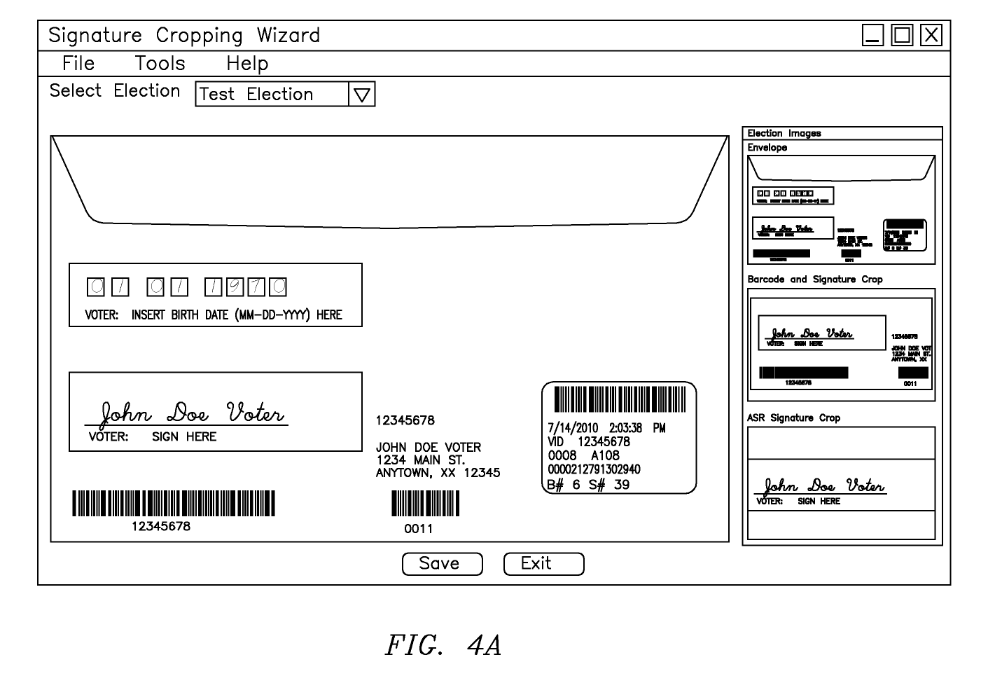

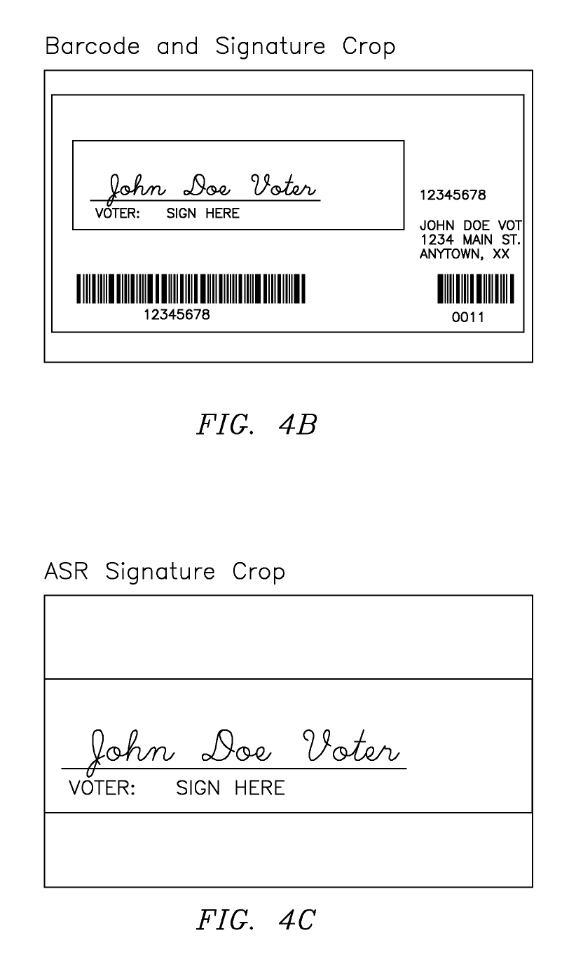

FIG. 4A illustrates an exemplary screen shot of the display device of central processing server 12 during the signature cropping configuration process. As can be seen, the imaging cropping tool is used to configure three different images that would be generated for each of the ballot envelopes: (1) an image of the entire ballot envelope (i.e., the image shown in the upper-right section of FIG. 4A); (2) an image of the signature box and barcodes on the ballot envelope the image shown in the middle-right section of FIG. 4A and in the enlarged view of FIG. 4B); and (3) an image of only the signature portion within the signature box (i.e., the image shown in the lower-right section of FIG. 4A and in the enlarged view of FIG. 4C). It will be seen that the image of the entire ballot envelope is provided to the voting jurisdiction as part of the audit trail for the election, the image of the signature box and barcodes on the ballot envelope is provided to workstations 20a, 20b and 20c for the manual signature comparison process and to voter registration system 14 as an update to the voter registration records, and the image of only the signature portion within the signature box is provided to automated signature recognition server 18 for the automated signature comparison process. It can be appreciated that a similar process is used to configure the cropping of the personal information box and the characters written in the designated input boxes for each of the ballot envelopes.

Referring back to FIG. 3, in step 102, central processing server 12 retrieves voter data from voter registration system 14 that corresponds to the voter identifier printed on the ballot envelope (i.e., the voter identifier included in the envelope data received from mail system 16). As discussed above, the voter data includes the voting precinct identifier associated with the registered voter, the voter eligibility status of the registered voter, one or more images of signatures known to be authored by the registered voter (e.g., the voter's signature from his/her voter card), and optionally personal information of the registered voter (e.g., birth date, driver's license number, residential address, etc.).

In step 104, central processing server 12 analyzes the received voter data to determine the voter eligibility status of the registered voter. In the exemplary embodiment, the voter eligibility status is provided as a numeric status code (wherein 0 indicates an invalid voter and 1 indicates a valid voter) and as a textual description of the voting status in the voter data. Alternatively, central processing server 12 may determine the voter eligibility status of the registered voter based on a list of invalid voters received from the official voter registration system. There are a variety of reasons why a registered voter who has been mailed an absentee ballot would be ineligible to vote, such as if the voter moved or died after the absentee ballot was mailed or if the voter has already voted in the election. In this case, the textual description of the voting status will indicate the specific reason that the voter is ineligible to vote. In step 106, if central processing server 12 determines that the registered voter is ineligible to vote, the appropriate envelope endorsement data will be transmitted to mail system 16 (as described in connection with step 130 below). However, if central processing server 12 determines that the registered voter is eligible to vote, then the process continues to step 108.

In step 108, central processing server 12 causes an automatic signature verification process to be performed with respect to the signature written on the ballot envelope. To do so, central processing server 12 transmits the image of the signature written on the ballot envelope (e.g., the image shown in the lower-right section of FIG. 4A and in FIG. 4C) and the images of the signatures of the registered voter (i.e., the signature images included in the voter data received from voter registration database 14) to automated signature recognition server 18 for electronic comparison, as described above. In step 110, if central processing server 12 receives a signal from automated signature recognition server 18 indicating that the signature written on the ballot envelope is verified, then the process continues to step 118, as described below. However, if central processing server 12 receives a signal from automated signature recognition server 18 indicating that the signature written on the ballot envelope is not verified, then the process continues to step 112.

In step 112, central processing server 12 causes a manual signature verification process to be performed with respect to the signature written on the ballot envelope. To do so, central processing server 12 transmits the image of the signature written on the ballot envelope (e.g., the image shown in the middle-right section of FIG. 4A and in FIG. 4B) and the images of the signatures of the registered voter (i.e., the signature images included in the voter data received from voter registration database 14) to one or workstations 20a, 20b and 20c for manual comparison. An election official then views and compares the signatures manually to ascertain whether the signatures are authored by the same individual (i.e., the registered voter), and provides input in step 114. In step 116, if central processing server 12 receives a signal from the workstation indicating that the signature written on the ballot envelope is not verified, then the appropriate envelope endorsement data will be transmitted to mail system 16 (as described in connection with step 130 below). However, if central processing server 12 receives a signal from the workstation indicating that the signature written on the ballot envelope is verified, then the process continues to step 120.

FIG. 5 illustrates an exemplary screen shot of the display device of one of workstations 20a, 20b and 20c during the manual signature verification process. As can be seen, the image of the signature written on the ballot envelope is displayed above the image of the signature from the voter card of the registered voter. In this example, the images of three different alternate signatures stored in voter registration system 14 are also displayed to the right of the envelope and voter card images, wherein any one of these images may be moved to the voter card image position by selecting the applicable “Move Left” button. In order to assist the election official in comparing the various signatures, a “Flip” toggled option is provided that changes the respective positions of the envelope image and voter card image, and a “Rotate” toggled option is provided that rotates the envelope image and voter card image so that the images can be viewed upside down. A “Pause” option is also provided to pause the manual signature verification process. Once the election official has compared the signatures as desired, the “Approve” option may be selected if he/she determines that the signatures are authored by the same individual, or, the “Reject” option may be selected if he/she determines that the signatures are not authored by the same individual.

In step 118, central processing server 12 causes an automatic personal information verification process to be performed with respect to the personal information written on the ballot envelope. To do so, central processing server 12 uses optical character recognition (OCR) or similar technologies to determine the characters written in each of the designated input boxes within the personal identification box on the ballot envelope (such as personal identification box 42 shown in FIG. 2). As discussed above, the personal information may include the voter's date of birth, the voter's driver's license number, the voter's residential address, or any other personal information stored in voter registration system 14. In the exemplary embodiment, OCR is applied to the image of the characters written in the designated input boxes that were cropped from the image of the ballot envelope, as discussed above.

Central processing server 12 then compares the personal information written on the ballot envelope (as determined through the use of OCR or similar technologies) to the corresponding personal information of the registered voter (i.e., the personal information included in the voter data received from voter registration database 14). In step 120, if central processing server 12 determines that the personal information written on the ballot envelope is verified, then the process continues to step 128, as described below. However, if central, processing server 12 determines that the personal information written on the ballot envelope is not verified, then the process continues to step 122.

In step 122, central processing server 12 causes a manual personal information verification process to be performed with respect to the personal information written on the ballot envelope. To do so, central processing server 12 transmits the image of the personal information written on the ballot envelope (e.g., the image of the personal information box) and the personal information of the registered voter to one or workstations 20a, 20b and 20c for manual comparison. An election official then views and compares the information manually to ascertain whether the personal information written on the ballot envelope corresponds to that of the registered voter, and provides input in step 124. In step 126, if central processing server 12 receives a signal from the workstation indicating that the personal information written on the ballot envelope is not verified, then the appropriate envelope endorsement data will be transmitted to mail system 16 (as described in connection with step 130 below). However, if central processing server 12 receives a signal from the workstation indicating that the personal information written on the ballot envelope is verified, then the process continues to step 128.

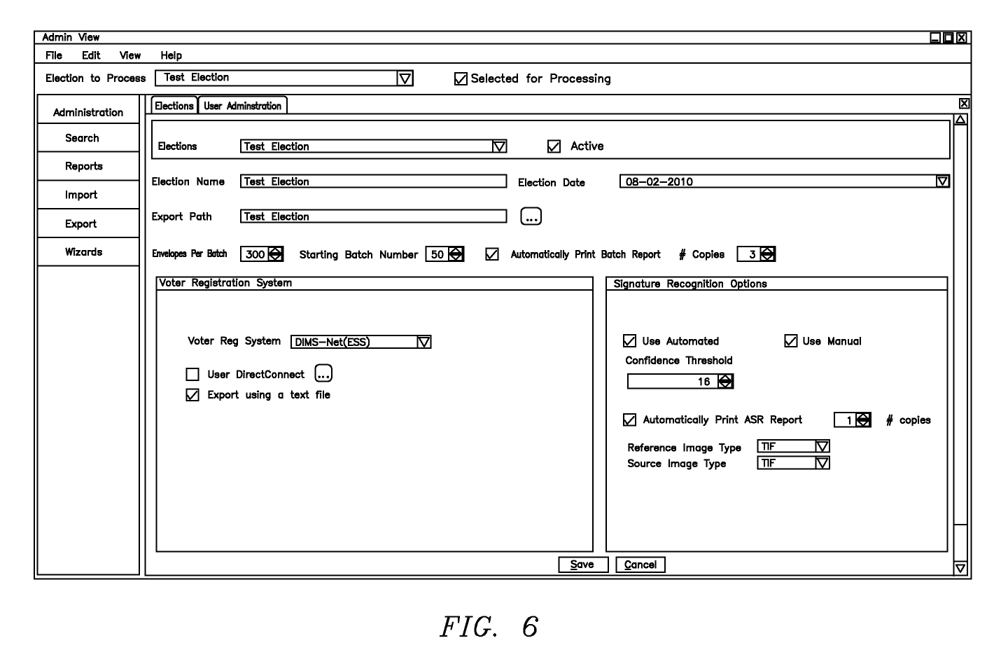

In step 128, central processing server determines the batch information for the ballot envelope if all of the verification steps described above have been passed. In the exemplary embodiment, the batch information includes the voting precinct identifier (which identifies the voting precinct of the registered voter), a batch number (which identifies a batch of envelopes associated with the voting precinct), and a sequence number (which identifies a sequential position of an envelope within the batch of envelopes). Preferably, the central processing server generates the batch and sequence numbers based on user-defined batch criteria for the voting precinct, as will be described in connection with FIG. 6.

FIG. 6 illustrates an exemplary screen shot of the display device of central processing server 12 during the batch set-up process. As can be seen, an election official is able to define the batch criteria for a particular election, wherein the batch criteria will apply to each voting precinct in the voting jurisdiction. In the illustrated example, the election official has selected a batch size of 300 ballot envelopes per batch from the drop-down box as shown, although any desirable batch size may be selected. The election official has also selected a starting batch number of 50 from the drop-down box as shown such that the first ballot envelope in the batch will be assigned a sequence number of 50. In this case, the election official has decided to reserve sequence numbers 1-49 for other ballot envelopes, such as ballot envelopes returned by military personnel. Of course, it should be understood that the starting sequence number will be 1 in many instances. Although not shown in FIG. 6, the election official is preferably able to select between daily batching and continuous batching. If daily batching is selected, the batch number will re-set to 1 each day during the voting period. As such, there will be multiple batches with the same batch number, in which case the date information (described below) is used to distinguish between different batches. If continuous batching is selected, the batch number will not re-set such that the batch number alone can be used to distinguish between different batches. In the illustrated example, the election official has also marked a checkbox indicating a selection to automatically print batch reports, and has selected 3 copies from the drop-down box as shown.

Referring still to FIG. 6, it can be seen that the election official is also able to make selections in the “Voter Registration System” box. Here, the election official has selected the type of voter registration system used by the voting jurisdiction from the drop-down box as shown, and has marked a checkbox indicating the type of connection to the voter registration system (i.e., either a direct connection or the export of a text file to a file location specified by the voting jurisdiction). The election official is also able to make selections in the “Signature Recognition Options” box. Here, the election official has marked checkboxes indicating selections to use both automated and manual signature verification (as discussed above in connection with steps 108-116). Of course, the election official may select either automated or manual signature verification, but not both. Because automated signature verification was selected, the election official has also selected a confidence threshold of 16 and the image types from the drop-down boxes as shown. In the illustrated example, the election official has also marked a checkbox indicating a selection to automatically print ASR reports, and has selected 1 copy from the drop-down box as shown.

In step 130, central processing server 12 transmits envelope endorsement data for the ballot envelope to mail system 16. The envelope endorsement data includes the date and time that the ballot envelope was processed, the voter identifier, the envelope status code, and the envelope identifier. The envelope endorsement data also includes batch information if the ballot envelope has passed all of the verification steps (discussed in connection with step 128 above). Alternatively, the envelope endorsement data includes exception information if the ballot envelope has failed any one of the verification steps. The exception information includes an exception code and a human-readable description of the exception associated with the ballot envelope. The human-readable description may provide a reason why the registered voter is not eligible to vote, an indication that the signature written on the ballot envelope does not correspond to the signature of the registered voter, or an indication that the personal information written on the ballot envelope does not correspond to the personal information of the registered voter. The envelope endorsement data may also be stored in central processing server 12 so as to create an electronic audit record for the ballot envelope. One skilled in the art will appreciate that the electronic audit record associated with each of the ballots processed by system 10 can be used to generate reports that can be compared to reports generated by the voter registration system of the voting jurisdiction.

In the exemplary embodiment, central processing server performs all of steps 100-130 for a particular ballot envelope in “live” time (i.e., as the ballot envelope is being processed by mail system 16 in communication with central processing server 12). Preferably, central processing server 12 provides a processing time in the range of 100 milliseconds to 500 milliseconds per ballot envelope (barring any need for manual signature verification and/or manual personal information verification).

The overall configuration and functionality of system 10 enables each of the ballot envelopes to be processed in a single pass through the system. There is no need to sort the ballot envelopes multiple times and the ballot envelopes are processed without human intervention (i.e., without requiring a human to handle the ballot envelopes). Accordingly, system 10 provides a labor and time savings over other systems known in the art and provides greater protection against human error. Of course, other advantages associated with the present invention will be readily apparent to one skilled in the art.

While the present invention has been described and illustrated hereinabove with reference to an exemplary embodiment, it should be understood that various modifications could be made to this embodiment without departing from the scope of the invention. For example, the verification of the personal information written on the ballot envelope as described in connection with steps 118-124 is optional and, as such, these steps need not be performed by system 10. Therefore, the invention is not to be limited to the exemplary embodiment described and illustrated hereinabove, except insofar as such limitations are included in the following claims.

What is claimed and desired to be secured by Letters Patent is as follows:

1. A ballot envelope processing system, comprising:
a processor operable to asynchronously process each of a plurality of ballot envelopes by:
receiving envelope data associated with a ballot envelope, wherein the envelope data comprises a voter identifier and an image of a signature written on the ballot envelope;
receiving voter data associated with the voter identifier, wherein the voter data comprises voter eligibility information and at least one image of a signature of a registered voter;
determining whether the registered voter associated with the voter identifier is eligible to vote based on the voter eligibility information;
determining whether the signature written on the ballot envelope corresponds to the signature of the registered voter;
generating envelope endorsement data for the ballot envelope, wherein the envelope endorsement data comprises one of (i) batch information if it is determined that the registered voter associated with the voter identifier is eligible to vote and the signature written on the ballot envelope corresponds to the signature of the registered voter or (ii) exception information if it is determined that the registered voter associated with the voter identifier is not eligible to vote or the signature written on the ballot envelope does not correspond to the signature of the registered voter; and
a storage device operable to store the envelope endorsement data associated with each of the ballot envelopes.

2. The system of claim 1, wherein the processor is in communication with a mail system, and wherein the processor is operable to receive the envelope data from the mail system and transmit the envelope endorsement data to the mail system.

3. The system of claim 2, wherein the envelope data received from the mail system comprises an image of the ballot envelope, and wherein the processor is operable to extract the image of the signature written on the ballot envelope from the image of the ballot envelope.

4. The system of claim 1, wherein the processor is in communication with a voter registration system, and wherein the processor is operable to receive the voter data from the voter registration system and transmit at least a portion of the envelope endorsement data and the image of the signature written on the ballot envelope to the voter registration system.

5. The system of claim 1, wherein the batch information comprises a voting precinct identifier, a batch number and a sequence number.

6. The system of claim 5, wherein the voting precinct identifier identifies a voting precinct of the registered voter, wherein the batch number identifies a batch of envelopes associated with the voting precinct, and wherein the sequence number identifies a sequential position of an envelope within the batch of envelopes.

7. The system of claim 5, wherein the processor generates the batch number and the sequence number based on user-defined batch criteria for the voting precinct.

8. The system of claim 1, wherein the exception information comprises a human-readable description of an exception.

9. The system of claim 8, wherein the human-readable description comprises a reason why the registered voter associated with the voter identifier is not eligible to vote.

10. The system of claim 8, wherein the human-readable description comprises an indication that the signature written on the ballot envelope does not correspond to the signature of the registered voter.

11. The system of claim 1, wherein the envelope endorsement data also comprises a date and a time that the ballot envelope is processed.

12. The system of claim 11, wherein the envelope endorsement data further comprises the voter identifier.

13. The system of claim 1, wherein the processor determines whether the signature written on the ballot envelope corresponds to the signature of the registered voter by causing an automated signature recognition program to compare the image of the signature written on the ballot envelope to the image of the signature of the registered voter.

14. The system of claim 1, wherein the processor is in communication with at least one workstation, and wherein the processor determines whether the signature written on the ballot envelope corresponds to the signature of the registered voter by causing the image of the signature written on the ballot envelope and the image of the signature of the registered voter to be displayed on the workstation and receiving user input from the workstation indicating whether the signature written on the ballot envelope corresponds to the signature of the registered voter.

15. A computer-readable medium having instructions stored thereon for execution by a processor to perform a method for processing ballot envelopes, the method comprising:
(a) receiving envelope data associated with a ballot envelope, wherein the envelope data comprises a voter identifier and an image of a signature written on the ballot envelope;
(b) receiving voter data associated with the voter identifier, wherein the voter data comprises voter eligibility information and at least one image of a signature of a registered voter;
(c) determining whether the registered voter associated with the voter identifier is eligible to vote based on the voter eligibility information;
(d) determining whether the signature written on the ballot envelope corresponds to the signature of the registered voter;
(e) generating envelope endorsement data for the ballot envelope, wherein the envelope endorsement data comprises one of (i) batch information if it is determined that the registered voter associated with the voter identifier is eligible to vote and the signature written on the ballot envelope corresponds to the signature of the registered voter or (ii) exception information if it is determined that the registered voter associated with the voter identifier is not eligible to vote or the signature written on the ballot envelope does not correspond to the signature of the registered voter;
(f) storing the envelope endorsement data for the ballot envelope; and
(g) repeating steps (a)-(f) for each of a plurality of ballot envelopes.

16. The computer-readable medium of claim 15, wherein the envelope data is received from a mail system in step (a), and wherein the method further comprises transmitting the envelope endorsement data to the mail system.

17. The computer-readable medium of claim 16, wherein the envelope data received from the mail system comprises an image of the ballot envelope, and wherein the method further comprises extracting the image of the signature written on the ballot envelope from the image of the ballot envelope.

18. The computer-readable medium of claim 15, wherein the voter data is received from a voter registration system in step (b), and wherein the method further comprises transmitting at least a portion of the envelope endorsement data and the image of the signature written on the ballot envelope to the voter registration system.

19. The computer-readable medium of claim 15, wherein the batch information comprises a voting precinct identifier, a batch number and a sequence number.

20. The computer-readable medium of claim 19, wherein the voting precinct identifier identifies a voting precinct of the registered voter, wherein the batch number identifies a batch of envelopes associated with the voting precinct, and wherein the sequence number identifies a sequential position of an envelope within the batch of envelopes.

21. The computer-readable medium of claim 19, wherein the batch number and the sequence number are generated based on user-defined batch criteria for the voting precinct.

22. The computer-readable medium of claim 15, wherein the exception information comprises a human-readable description of an exception.

23. The computer-readable medium of claim 22, wherein the human-readable description comprises a reason why the registered voter associated with the voter identifier is not eligible to vote.

24. The computer-readable medium of claim 22, wherein the human-readable description comprises an indication that the signature written on the ballot envelope does not correspond to the signature of the registered voter.

25. The computer-readable medium of claim 15, wherein the envelope endorsement data also comprises a date and a time that the ballot envelope is processed.

26. The computer-readable medium of claim 25, wherein the envelope endorsement data further comprises the voter identifier.

27. The computer-readable medium of claim 15, wherein step (d) is performed by causing an automated signature recognition program to compare the image of the signature written on the ballot envelope to the image of the signature of the registered voter.

28. The computer-readable medium of claim 15, wherein step (d) is performed by causing the image of the signature written on the ballot envelope and the image of the signature of the registered voter to be displayed on a workstation and receiving user input from the workstation indicating whether the signature written on the ballot envelope corresponds to the signature of the registered voter.

29. The computer-readable medium of claim 15, wherein the ballot envelopes are processed asynchronously.

30. A ballot envelope processing system, comprising:
a processor operable to asynchronously process each of a plurality of ballot envelopes by:
receiving envelope data associated with a ballot envelope, wherein the envelope data comprises a voter identifier, an image of a signature written on the ballot envelope, and an image of personal information written on the ballot envelope;
receiving voter data associated with the voter identifier, wherein the voter data comprises voter eligibility information, at least one image of a signature of a registered voter, and personal information of the registered voter;
determining whether the registered voter associated with the voter identifier is eligible to vote based on the voter eligibility information;
determining whether the signature written on the ballot envelope corresponds to the signature of the registered voter;
determining whether the personal information written on the ballot envelope corresponds to the personal information of the registered voter;
generating envelope endorsement data for the ballot envelope, wherein the envelope endorsement data comprises one of (i) hatch information if it is determined that the registered voter associated with the voter identifier is eligible to vote, the signature written on the ballot envelope corresponds to the signature of the registered voter, and the personal information written on the ballot envelope corresponds to the personal information of the registered voter or (ii) exception information if it is determined that the registered voter associated with the voter identifier is not eligible to vote, the signature written on the ballot envelope does not correspond to the signature of the registered voter, or the personal information written on the ballot envelope does not correspond to the personal information of the registered voter; and
a storage device operable to store the envelope endorsement data associated with each of the ballot envelopes.

31. The system of claim 30, wherein the processor is in communication with a mail system, and wherein the processor is operable to receive the envelope data from the mail system and transmit the envelope endorsement data to the mail system.

32. The system of claim 31, wherein the envelope data received from the mail system comprises an image of the ballot envelope, and wherein the processor is operable to extract the image of the signature written on the ballot envelope and the image of the personal information written on the ballot envelope from the image of the ballot envelope.

33. The system of claim 30, wherein the processor is in communication with a voter registration system, and wherein the processor is operable to receive the voter data from the voter registration system and transmit at least a portion of the envelope endorsement data and the image of the signature written on the ballot envelope to the voter registration system.

34. The system of claim 30, wherein the batch information comprises a voting precinct identifier, a batch number and a sequence number.

35. The system of claim 34, wherein the voting precinct identifier identifies a voting precinct of the registered voter, wherein the batch number identifies a batch of envelopes associated with the voting precinct, and wherein the sequence number identifies a sequential position of an envelope within the batch of envelopes.

36. The system of claim 34, wherein the processor generates the batch number and the sequence number based on user-defined batch criteria for the voting precinct.

37. The system of claim 30, wherein the exception information comprises a human-readable description of an exception.

38. The system of claim 37, wherein the human-readable description comprises a reason why the registered voter associated with the voter identifier is not eligible to vote.

39. The system of claim 37, wherein the human-readable description comprises an indication that the signature written on the ballot envelope does not correspond to the signature of the registered voter.

40. The system of claim 37, wherein the human-readable description comprises an indication that the personal information written on the ballot envelope does not correspond to the personal information of the registered voter.

41. The system of claim 30, wherein the envelope endorsement data also comprises a date and a time that the ballot envelope is processed.

42. The system of claim 41, wherein the envelope endorsement data further comprises the voter identifier.

43. The system of claim 30, wherein the processor determines whether the signature written on the ballot envelope corresponds to the signature of the registered voter by causing an automated signature recognition program to compare the image of the signature written on the ballot envelope to the image of the signature of the registered voter.

44. The system of claim 30, wherein the processor is in communication with at least one workstation, and wherein the processor determines whether the signature written on the ballot envelope corresponds to the signature of the registered voter by causing the image of the signature written on the ballot envelope and the image of the signature of the registered voter to be displayed on the workstation and receiving user input from the workstation indicating whether the signature written on the ballot envelope corresponds to the signature of the registered voter.

45. The system of claim 30, wherein the personal information of the registered voter comprises one of a driver's license number of the registered voter, a birth date of the registered voter, or a residential address of the registered voter.

46. The system of claim 30, wherein the processor is operable to perform optical character recognition on the image of the personal information written on the ballot envelope in order to ascertain the personal information written on the ballot envelope.

47. A computer-readable medium having instructions stored thereon for execution by a processor to perform a method for processing ballot envelopes, the method comprising:
(a) receiving envelope data associated with a ballot envelope, wherein the envelope data comprises a voter identifier, an image of a signature written on the ballot envelope, and an image of personal information written on the ballot envelope;
(b) receiving voter data associated with the voter identifier, wherein the voter data comprises voter eligibility information, at least one image of a signature of a registered voter, and personal information of the registered voter;
(c) determining whether the registered voter associated with the voter identifier is eligible to vote based on the voter eligibility information;
(d) determining whether the signature written on the ballot envelope corresponds to the signature of the registered voter;
(e) determining whether the personal information written on the ballot envelope corresponds to the personal information of the registered voter;
(f) generating envelope endorsement data for the ballot envelope, wherein the envelope endorsement data comprises one of (i) batch information if it is determined that the registered voter associated with the voter identifier is eligible to vote, the signature written on the ballot envelope corresponds to the signature of the registered voter, and the personal information written on the ballot envelope corresponds to the personal information of the registered voter or (ii) exception information if it is determined that the registered voter associated with the voter identifier is not eligible to vote, the signature written on the ballot envelope does not correspond to the signature of the registered voter, or the personal information written on the ballot envelope does not correspond to the personal information of the registered voter;
(g) storing the envelope endorsement data for the ballot envelope; and
(h) repeating steps (a)-(g) for each of a plurality of ballot envelopes.

48. The computer-readable medium of claim 47, wherein the envelope data is received from a mail system in step (a), and wherein the method further comprises transmitting the envelope endorsement data to the mail system.

49. The computer-readable medium of claim 48, wherein the envelope data received from the mail system comprises an image of the ballot envelope, and wherein the method further comprises extracting the image of the signature written on the ballot envelope and the image of the personal information written on the ballot envelope from the image of the ballot envelope.

50. The computer-readable medium of claim 47, wherein the voter data is received from a voter registration system in step (b), and wherein the method further comprises transmitting at least a portion of the envelope endorsement data and the image of the signature written on the ballot envelope to the voter registration system.

51. The computer-readable medium of claim 47, wherein the batch information comprises a voting precinct identifier, a batch number and a sequence number.

52. The computer-readable medium of claim 51, wherein the voting precinct identifier identities a voting precinct of the registered voter, wherein the batch number identifies a batch of envelopes associated with the voting precinct, and wherein the sequence number identifies a sequential position of an envelope within the batch of envelopes.

53. The computer-readable medium of claim 51, wherein the batch number and the sequence number are generated based on user-defined batch criteria for the voting precinct.

54. The computer-readable medium of claim 47, wherein the exception information comprises a human-readable description of an exception.

55. The computer-readable medium of claim 54, wherein the human-readable description comprises a reason why the registered voter associated with the voter identifier is not eligible to vote.

56. The computer-readable medium of claim 54, wherein the human-readable description comprises an indication that the signature written on the ballot envelope does not correspond to the signature of the registered voter.

57. The computer-readable medium of claim 54, wherein the human-readable description comprises an indication that the personal information written on the ballot envelope does not correspond to the personal information of the registered voter.

58. The computer-readable medium of claim 47, wherein the envelope endorsement data also comprises a date and a time that the ballot envelope is processed.

59. The computer-readable medium of claim 58, wherein the envelope endorsement data further comprises the voter identifier.

60. The computer-readable medium of claim 47, wherein step (d) is performed by causing an automated signature recognition program to compare the image of the signature written on the ballot envelope to the image of the signature of the registered voter.

61. The computer-readable medium of claim 47, wherein step (d) is performed by causing the image of the signature written on the ballot envelope and the image of the signature of the registered voter to be displayed on a workstation and receiving user input from the workstation indicating whether the signature written on the ballot envelope corresponds to the signature of the registered voter.

62. The computer-readable medium of claim 47, wherein the personal information of the registered voter comprises one of a driver's license number of the registered voter, a birth date of the registered voter, or a residential address of the registered voter.

63. The computer-readable medium of claim 47, wherein the method further comprises performing optical character recognition on the image of the personal information written on the ballot envelope in order to ascertain the personal information written on the ballot envelope.

64. The computer-readable medium of claim 47, wherein the ballot envelopes are processed asynchronously.

65. A ballot envelope processing system, comprising:
a processor operable to asynchronously process each of a plurality of ballot envelopes by:
receiving envelope data associated with a ballot envelope;
generating envelope endorsement data for the ballot envelope, wherein the envelope endorsement data comprises one of (i) batch information comprising a voting precinct identifier that identities a voting precinct of a registered voter, a batch number that identifies a batch of envelopes associated with the voting precinct, and a sequence number that identifies a sequential position of an envelope within the hatch of envelopes or (ii) exception information comprising a human-readable description of a reason why the registered voter is not eligible to vote or an indication that a signature written on the ballot envelope does not correspond to a signature of the registered voter; and
a storage device operable to store the envelope endorsement data associated with each of the ballot envelopes.

66. The system of claim 65, wherein the processor is in communication with a mail system, and wherein the processor is operable to receive the envelope data from the mail system and transmit the envelope endorsement data to the mail system.

67. The system of claim 65, wherein the processor is in communication with a voter registration system, and wherein the processor is operable to transmit at least a portion of the envelope endorsement data to the voter registration system.

68. The system of claim 65, wherein the processor generates the batch number and the sequence number based on user-defined batch criteria for the voting precinct.

69. The system of claim 65, wherein the envelope endorsement data also comprises a date and a time that the ballot envelope is processed.

70. The system of claim 69, wherein the envelope endorsement data further comprises a voter identifier of the registered voter.

71. A computer-readable medium having instructions stored thereon for execution by a processor to perform a method for processing ballot envelopes, the method comprising:
(a) receiving envelope data associated with a ballot envelope;
(b) generating envelope endorsement data for the ballot envelope, wherein the envelope endorsement data comprises one of wherein the envelope endorsement data comprises one of (i) batch information comprising a voting precinct identifier that identifies a voting precinct of a registered voter, a batch number that identifies a batch of envelopes associated with the voting precinct, and a sequence number that identifies a sequential position of an envelope within the batch of envelopes or (ii) exception information comprising a human-readable description of a reason why the registered voter is not eligible to vote or an indication that a signature written on the ballot envelope does not correspond to a signature of the registered voter;
(c) storing the envelope endorsement data for the ballot envelope; and
(d) repeating steps (a)-(c) for each of a plurality of ballot envelopes.

72. The computer-readable medium of claim 71, wherein the envelope data is received from a mail system in step (a), and wherein the method further comprises transmitting the envelope endorsement data to the mail system.

73. The computer-readable medium of claim 71, wherein the method further comprises transmitting at least a portion of the envelope endorsement data to a voter registration system.

74. The computer-readable medium of claim 71, wherein the batch number and the sequence number are generated based on user-defined batch criteria for the voting precinct.

75. The computer-readable medium of claim 71, wherein the envelope endorsement data also comprises a date and a time that the ballot envelope is processed.

76. The computer-readable medium of claim 75, wherein the envelope endorsement data further comprises a voter identifier of the registered voter.

77. The computer-readable medium of claim 71, wherein the ballot envelopes are processed asynchronously.

78. A ballot envelope processing system, comprising:
a processor operable to asynchronously process each of a plurality of ballot envelopes by:
verifying that a registered voter associated with a ballot envelope is eligible to vote;
verifying that a signature written on the ballot envelope corresponds to a signature of the registered voter;
generating endorsement information comprising one of (i) hatch information if it is determined that the registered voter associated with the ballot envelope is eligible to vote and the signature written on the ballot envelope corresponds to the signature of the registered voter of (ii) exception information if is determined that the registered voter associated with the ballot envelope is not eligible to vote or the signature written on the ballot envelope does not correspond to the signature of the registered voter; and
a storage device operable to store the batch information and the exception information, as applicable, for each of the ballot envelopes.

79. The system of claim 78, wherein the processor is in communication with a mail system, and wherein the processor is operable to transmit the hatch information and the exception information, as applicable, for each of the ballot envelopes to the mail system.

80. The system of claim 78, wherein the processor is in communication with a voter registration system, and wherein the processor is operable to transmit the batch information and the exception information, as applicable, for each of the ballot envelopes to the voter registration system.

81. The system of claim 78, wherein the batch information comprises a voting precinct identifier, a batch number and a sequence number.

82. The system of claim 81, wherein the voting precinct identifier identifies a voting precinct of the registered voter, wherein the batch number identifies a batch of envelopes associated with the voting precinct, and wherein the sequence number identifies a sequential position of an envelope within the batch of envelopes.

83. The system of claim 78, wherein the processor generates the hatch number and the sequence number based on user-defined batch criteria for the voting precinct.

84. The system of claim 78, wherein the exception information comprises a reason why the registered voter associated with the ballot envelope is not eligible to vote.

85. The system of claim 78, wherein the exception information comprises an indication that the signature written on the ballot envelope does not correspond to the signature of the registered voter.

86. The system of claim 78, wherein the processor is also operable to verify that personal information written on the ballot envelope corresponds to personal information of the registered voter.

87. The system of claim 86, wherein the exception information comprises an indication that the personal information written on the ballot envelope does not correspond to the personal information of the registered voter.

88. The system of claim 86, wherein the personal information of the registered voter comprises one of a driver's license number of the registered voter, a birth date of the registered voter, or a residential address of the registered voter.

89. A computer-readable medium having instructions stored thereon for execution by a processor to perform a method for processing ballot envelopes, the method comprising:
(a) verifying that a registered voter associated with a ballot envelope is eligible to vote;
(b) verifying that a signature written on the ballot envelope corresponds to a signature of the registered voter;
(c) generating endorsement information comprising one of (i) batch information if it is determined that the registered voter associated with the ballot envelope is eligible to vote and the signature written on the ballot envelope corresponds to the signature of the registered voter of (ii) exception information if it is determined that the registered voter associated with the ballot envelope is not eligible to vote or the signature written on the ballot envelope does not correspond to the signature of the registered voter;
(d) storing the batch information or the exception information, as applicable, for the ballot envelope; and
(e) repeating steps (a)-(d) for each of a plurality of ballot envelopes.

90. The computer-readable medium of claim 89, wherein the method further comprises transmitting the batch information or the exception information, as applicable, for the ballot envelope to the mail system.

91. The computer-readable medium of claim 89, wherein the method further comprises transmitting the batch information or the exception information, as applicable, for the ballot envelope to the voter registration system.

92. The computer-readable medium of claim 89, wherein the batch information comprises a voting precinct identifier, a batch number and a sequence number.

93. The computer-readable medium of claim 92, wherein the voting precinct identifier identifies a voting precinct of the registered voter, wherein the batch number identifies a batch of envelopes associated with the voting precinct, and wherein the sequence number identifies a sequential position of an envelope within the batch of envelopes.

94. The computer-readable medium of claim 92, wherein the hatch number and the sequence number are generated based on user-defined batch criteria for the voting precinct.

95. The computer-readable medium of claim 89, wherein the exception information comprises a reason why the registered voter associated with the ballot envelope is not eligible to vote.

96. The computer-readable medium of claim 89, wherein the exception information comprises an indication that the signature written on the ballot envelope does not correspond to the signature of the registered voter.

97. The computer-readable medium of claim 89, wherein the method further comprises verifying that personal information written on the ballot envelope corresponds to personal information of the registered voter.

98. The system of claim 97, wherein the exception information comprises an indication that the personal information written on the ballot envelope does not correspond to the personal information of the registered voter.

99. The system of claim 97, wherein the personal information of the registered voter comprises one of a driver's license number of the registered voter, a birth date of the registered voter, or a residential address of the registered voter.

100. The computer-readable medium of claim 89, wherein the ballot envelopes are processed asynchronously.
